(19) United States
(12) Patent Application Publication
(10) Pub. No.: US 2025/0205619 A1
(43) Pub. Date: Jun. 26, 2025

(54) UNIFORM SPRAY-COATING, CUMULATIVELY-STACKING AND SQUEEZING SOLID-LIQUID SEPARATION SYSTEM

(71) Applicants: UNIVERSITY OF SCIENCE AND TECHNOLOGY BEIJING, Beijing (CN); SUZHOU WEIHANG ENVIRONMENTAL TECHNOLOGY CO., LTD., Suzhou, Jiangsu (CN); SHENGSHI WEILAN (Shandong) ENVIRONMENTAL SCIENCE & TECHNOLOGY CO., LTD., Yantai, Shandong (CN); BEIJING JINYU MANGROVE ENVIRONMENTAL PROTECTION TECHNOLOGY CO., LTD., Beijing (CN)

(72) Inventors: Chen HONG, Beijing (CN); Yanxiao SI, Beijing (CN); Jirong LI, Beijing (CN); Yang WANG, Beijing (CN); Yi XING, Beijing (CN); Wei YUE, Beijing (CN)

(21) Appl. No.: 18/848,199

(22) PCT Filed: Jul. 12, 2022
(86) PCT No.: PCT/CN2022/105103

§ 371 Date: Sep. 18, 2024

(30) Foreign Application Priority Data
Apr. 7, 2022 (CN) 20221036861.0
Apr. 7, 2022 (CN) 202210362474.5
Apr. 7, 2022 (CN) 202210363856.X

(51) Int. Cl. B01D 25/26; B01D 25/00; B01D 25/30; B01D 25/38

(52) U.S. Cl. CPC B01D 25/26; B01D 25/001; B01D 25/30; B01D 25/305; B01D 25/383; B01D 25/386; B01D 2201/202

(57) ABSTRACT

A solid-liquid separation system having a filter cylinder, a filter cloth laying assembly, an assembly for carrying and moving the filter cylinder, a squeezing assembly, and an assembly for laying a filter cloth, unloading materials and rolling up a filter cloth. The assembly for carrying and moving the filter cylinder is located below the filtering cylinder and includes a working position A and a working position B, and the squeezing assembly is located above the filtering cylinder at the working position B. The filter cloth laying assembly includes a laying and folding component and a dispensing component, and the dispensing component is located above the filter cylinder. The laying and folding component is used for laying a filter cloth in the filter cylinder, and the dispensing component is used for spraying downward materials to be treated onto the filter cloth.

The application claims the priority rights of Chinese Patent Application No. 202210362474.5 filed with the State Intellectual Property Office of China on Apr. 7, 2022, Chinese Patent Application No. 202210363861.0 filed with the State Intellectual Property Office of China on Apr. 7, 2022, and Chinese Patent Application No. 202210363856X filed with the State Intellectual Property Office of China on Apr. 7, 2022, the entire contents of which are incorporated herein by reference.

### FIELD

The present application relates to a solid-liquid separation device, specifically, the solid-liquid separation device is used to uniformly spray a solid material containing liquid, and stack and squeeze multiple layers of solid materials to achieve solid-liquid separation.

### BACKGROUND

There are many methods for solid-liquid separation, including pressing, squeezing, and centrifugation etc., and correspondingly various solid-liquid separation equipments are employed. At present the most widely used equipment is selected from belt dehydrator and plate-and-frame type pressure filter. When a belt dehydrator is employed, material is distributed between two layers of filter belts, and is pressed by a pressure roller. There is advantage that the material is pressed at large compression limit because the filter belt is made of soft material and forms a cavity not being with a fixed volume. Whereas there are problems such as short squeezing time and low squeezing pressure. Although the filtration time of the plate-and-frame type pressure filter is relatively long, there is a fixed-volume cavity between the two filter plates, and the degree of material compression is limited. At the same time, the filtration pressure provided by the slurry pump and diaphragm pump is limited, and paste materials cannot be processed without additional water.

Therefore, it is necessary to develop new squeezing equipment and process method for treating high-water-content material, which has the characteristics of high squeezing pressure, high squeezing limit and long squeezing time, so as to improve the efficiency and effect of material distribution and dehydration.

### SUMMARY

A first aspect, the present application is to provide a filter cloth laying assembly through which materials is sprayed downward. The filter cloth laying assembly is configured to lay the filter cloth in layers, materials is sprayed downward and on a surface of the filter cloth from the apparatus. So Material is laid evenly, and the space occupied by the filter cloth laying assembly is reduced.

A second aspect, the present application is to provide a solid-liquid separation system being modular, in which the positions and combinations of the apparatuses involved in the solid-liquid separation system are diverse and easily adjusted. Thereby it is improved on the effect and efficiency of laying the filter cloth and distributing materials, and further the efficiency of solid-liquid separation is improved.

A third aspect, the present application is to provide an apparatus for laying and rolling up a filter cloth, which is compact and occupies a small space, and by which the filter cloth is effectively cleaned after unloading materials.

The solid-liquid separation system of the present application includes: a filter cylinder, an assembly for carrying and moving the filter cylinder, a filter cloth laying assembly, a squeezing assembly, and an apparatus for arranging a filter cloth and unloading materials. The squeezing assembly is located above the filter cylinder, and the assembly for carrying and moving the filter cylinder is located below the filter cylinder. In a horizontal direction, the filter cloth laying assembly and the squeezing assembly are arranged side by side. The filter cylinder is configured to move back and forth below the filter cloth laying assembly and the squeezing assembly through the assembly for carrying and moving the filter cylinder. The apparatus for arranging a filter cloth and unloading materials is located on a side of the filter cylinder.

In the solid-liquid separation system of the present application, materials is sprayed on an upper opening of the filter cylinder, the multiple layers of materials are respectively wrapped by adjacent filter cloths, and the multiple layers of materials are vertically arranged in a vertical direction of the filter cylinder. Each layer of materials is laid evenly in the horizontal direction. In the solid-liquid separation system of the present application, a plurality of equipments composed of a filter cylinder, a working position A of the assembly for carrying and moving the filter cylinder, and the apparatus for arranging a filter cloth and unloading materials can be arranged around the squeezing assembly, thereby greatly improving the working efficiency of the solid-liquid separation system.

### BRIEF DESCRIPTION OF THE DRAWINGS

FIG. 1 is a schematic diagram of a filter cylinder of a solid-liquid separation system of the present application;

FIG. 2 is a schematic top view of a filter cylinder of a solid-liquid separation system of the present application;

FIG. 3 is a schematic diagram in distributing materials in a filter cylinder of the present application;

FIG. 4 is a schematic diagram in a working position A and a working position B of the filter cylinder;

FIG. 5 is a schematic diagram in a working position A of a filter cylinder;

FIG. 6 is a schematic diagram in a working position B of a filter cylinder;

FIG. 7 is a schematic diagram of positions of an assembly for carrying and moving a filter cylinder and an assembly for laying a filter cloth, and unloading materials and rolling up a filter cloth;

FIG. 8 is a schematic diagram of a solid-liquid separation system when a front cloth pressing member is configured to press down a filter cloth during laying a filter cloth by a filter cloth laying assembly;

FIG. 9 is a schematic diagram of a solid-liquid separation system when a cloth folding and scraping member is configured to be in a rear end of a filter cylinder during laying a filter cloth by a filter cloth laying assembly;

FIG. 10 is a schematic diagram of working positions of a wrinkle removal roller during rolling up a filter cloth by an apparatus for laying a filter, unloading materials and rolling up a filter cloth;

FIG. 11 is a schematic diagram of assembling a front cloth pressing member, a rear cloth pressing member and a cloth folding and scraping member;

FIG. 12 is a right side view of the front cloth pressing member, the rear cloth pressing member and the cloth folding and scraping member in FIG. 11;

FIG. 13 is a schematic diagram of a squeezing assembly in other embodiments;

FIG. 14 is a schematic diagram of a guide rail;

FIG. 15 is a schematic diagram showing the filter cloth and materials on a movable bottom plate.

FIG. 16 is a schematic diagram of a solid-Liquid separation system being in a straight line for multiple uniform spraying, cumulatively laying and squeezing;

FIG. 17 is a top view of FIG. 16;

FIG. 18 is a schematic diagram of a solid-Liquid separation system being in an L shape for multiple uniform spraying, cumulatively laying and squeezing;

FIG. 19 is a schematic diagram of a solid-Liquid separation system being in a T shape for uniform spraying, cumulatively laying and squeezing;

FIG. 20 is a schematic diagram of a solid-Liquid separation system being in a cross shape for multiple uniform spraying, cumulatively laying and squeezing.

### DETAILED DESCRIPTION

A solid-liquid separation system and the solid-liquid separation method of the present application are described in detail below. The protection scope of the present application is not limited, and the protection scope is defined by the claims. The disclosed details are used for thoroughly understanding the various disclosed embodiments. However, one skilled in the art can know that embodiments may be implemented without one or more of these details, and with other materials and the like.

Unless the context requires, in the specification and claims, the term “comprising” or “containing” should be interpreted as an open-end and inclusive meaning, that is, “including, but not limited to”.

The “embodiment”, “an embodiment”, “another embodiment” or “some embodiments” mentioned in the specification refers to that the specific features, structures or characteristics described in the embodiment are included in at least one embodiment. Thus, “an embodiment,” “an embodiment,” “another embodiment,” or “some embodiments” are not necessarily all included in the same embodiment. Furthermore, the specific features, structures or characteristics may be combined in any manner in one or more embodiments. Each feature disclosed in the specification may be replaced by any alternative feature that can have the same, equivalent or similar function. Therefore, unless otherwise specified, the disclosed features are only general examples of equivalent or similar features.

The orientation terms such as up, down, left, right, front and rear in the application are used based on the positions shown in the figures. If the figures are different, the corresponding positions may also change accordingly, so it should not be understood as limiting the scope of the claims.

Materials to be treated in the present application is a mixture of solid and liquid, for example, a water-containing material. There is no limit on the water content.

A solid-liquid separation system or a solid-liquid separation method of the present application is preferably used for solid-liquid separation of sludge with high water content.

A cross section of a filter cylinder of the present application is configured as square or rectangular.

One aspect, in a solid-liquid separation system of the present application, materials to be treated is sprayed downward on a surface of a filter cloth and is evenly laid.

A solid-liquid separation system includes a filter cylinder and a filter cloth laying assembly. The filter cloth laying assembly includes a laying and folding component and a dispensing component, and the dispensing component is located above the filter cylinder. The laying and folding component is used for laying the filter cloth in the cylinder body, and the dispensing component is used for spraying downward materials to be treated onto the filter cloth.

In some embodiments, the filter cloth laying assembly includes a laying and folding component and a dispensing component, and the dispensing component is configured to be located above a filter cylinder. The laying and folding component is used for laying the filter cloth in the filter cylinder, and the dispensing component is used for spraying downward materials to be treated onto the filter cloth.

In some embodiments, the filter cloth laying assembly includes a telescopic pressing plate, a front cloth pressing member, a rear cloth pressing member and a cloth folding and scraping member. In a movement direction of the filter cloth, the front cloth pressing member and the rear cloth pressing member are respectively provided on a first side and a second side, opposite to each other, of a top of the filter cylinder. The telescopic pressing plate is fixed above the filter cylinder, and is located over the front cloth pressing member. The cloth folding and scraping member is configured to move back and forth between the first side and the second side of the filter cylinder to fold the filter cloth.

The telescopic pressing plate is capable of telescopically moving up and down. The telescopic pressing plate and the front cloth pressing member are configured to alternately press down the filter cloth on the first side of the filter cylinder. The rear cloth pressing member is configured to press down the filter cloth on the second side of the filter cylinder.

Through the arrangement of the laying and folding component, when the filter cloth is laid from the first side to the second side of the filter cylinder, the front cloth pressing member presses down the filter cloth on the first side onto the filter cylinder; the cloth folding and scraping member pushes the filter cloth to move toward the second side of the filter cylinder; and when the cloth folding and scraping member reaches the second side of the filter cylinder, the rear cloth pressing member presses down the filter cloth on the second side onto the filter cylinder, and the cloth folding and scraping member returns to its original position. After the filter cloth is laid between the first side and the second side of the filter cylinder each time, the dispensing component sprays materials to be treated on the filter cloth. When the filter cloth is laid next time, the cloth folding and scraping member can flatten materials placed under the filter cloth. The above movements are repeated to lay several layers of materials wrapped by the filter cloth in the filter cylinder.

There are several ways to fix the telescopic pressing plate and the cloth folding and scraping member, as long as the above functions can be achieved.

In a certain embodiment, the telescopic pressing plate and the cloth folding and scraping member are fixed on a frame outside the filter cylinder.

A first frame is arranged on an outer periphery of a cylinder body of the filter cylinder, and a top of the first frame is higher than a top of the cylinder body. An upper of the telescopic pressing plate is fixed on the first frame, the telescopic pressing plate can be stretched out and drawn back up and down and is located over the front cloth pressing member. The front cloth pressing member, the rear cloth pressing member and the cloth folding and scraping member are all arranged on the first frame, the front cloth pressing member is located on the first side of the top of the cylinder body, and the rear cloth pressing member is located on the second side of the top of the cylinder body. The telescopic pressing plate and the front cloth pressing member are configured to press down the filter cloth on the first side of the cylinder body alternately. The cloth folding and scraping member is configured to move back and forth between the first side and the second side of the cylinder body to lay the filter cloth, and the rear cloth pressing member presses down the filter cloth on the second side of the cylinder body.

The first frame arranged outside the cylinder body can be in various structures, as long as it does not affect the horizontal movement of the cylinder body in a certain direction.

In some embodiments, the front cloth pressing member includes a telescopic cloth pressing rod and a first support seat being capable of moving up and down. The front cloth pressing members are arranged in pairs at two ends of the first side of the top of the cylinder body. The cloth pressing rod of the front cloth pressing member can be horizontally stretched out and drawn back along the first side of the cylinder body.

In some embodiments, the rear cloth pressing member includes a telescopic cloth pressing rod and a second support seat being capable of moving up and down. The rear cloth pressing members are arranged in pairs at two ends of the second side of the top of the cylinder body. The cloth pressing rod of the rear cloth pressing member can be horizontally stretched out and drawn back along the second side of the cylinder body.

In some embodiments, a lower of the telescopic pressure plate has a first groove, which is open downward. Both ends of the first groove in an extension direction of the first side of the top of the cylinder body are respectively provided with an opening. The cloth pressing rod of the front cloth pressing member is configured to be inserted into the first groove from the openings at both ends of the first groove respectively, and can be pulled out of the first groove from a downward opening of the first groove to separate from the telescopic pressing plate.

Through the arrangement of the telescopic pressing plate and the front cloth pressing member, the telescopic pressing plate and the front cloth pressing member alternately press down the filter cloth on the first side of the filter cylinder.

In some embodiments, the cloth folding and scraping member includes a push plate, a third support seat and a movable slide rail. Two movable slide rails are respectively attached on the first frame located on two sides of the cylinder body in a movement direction of the filter cloth, and are respectively located on a side of the first support seat of the front cloth pressing member opposite to the cylinder body. The two third support seats are respectively located on two movable slide rails, and the two movable slide rails are used for commonly connecting with and supporting the push plate. The push plate is configured to cross over the top of the cylinder body.

Alternatively, the movable slide rails are attached to the first frame and located above the cylinder body, and the third support seats are hung on the movable slide rails. A bottom of the third support seats are connected with the push plate, and the push plate is configured to cross over the top of the cylinder body.

The third support seats drive the push plate to move back and forth between the first side and a second side of the cylinder body, so as to lay the filter cloth on the cylinder body and flatten materials under the filter cloth.

In some embodiments, a lower of the push plate has a second groove, which is open downward. Both ends of the second groove in an extension direction of the second side of the top of the cylinder body are respectively provided with an opening. The cloth pressing rod of the rear cloth pressing member is configured to be inserted into the second groove from the openings at both ends of the second groove respectively, and can be pulled out of the second groove from a downward opening of the second groove to separate from the push plate when the second support seat is descended.

The push plate of the cloth folding and scraping member has a width in a movement direction of the filter cloth, and the push plate can be defined as a front part and a rear part along a width direction. The rear part is closer to the second side of the cylinder body than the front part. The front part of the push plate is connected with the third support seat, and a lower surface of the rear part of the push plate is provided with the second groove.

Through the cooperation of the push plate and the rear cloth pressing member, the filter cloth on the second side of the cylinder body is pressed down on the cylinder body by the rear cloth pressing member.

In some embodiments, when the telescopic pressing plate is in an upwardly retracted state and the front cloth pressing member is in a downwardly moved state, a distance between the telescopic pressing plate and the front cloth pressing member is greater than the thickness of the push plate of the cloth folding and scraping member.

The dispensing component is fixed on the first frame and is located over the cylinder body.

The filter cloth laying assembly of the present application is used to lay the filter cloths in layers in the filter cylinder when materials to be treated is sprayed downward from the top of the filter cylinder. Multiple layers of materials to be treated are laid vertically in the cylinder body, and each layer of materials to be treated is wrapped by filter cloth. That is, two layers of the filter cloth are sandwiched between two adjacent layers of materials, and materials is evenly laid between the upper layer and the lower layer of the filter cloth.

The solid-liquid separation system of the present application can realize to uniformly spray materials and squeeze multiple layers of materials, and can also be called a solid-liquid separation system for uniform spray-coating, cumulatively laying and squeezing.

In some embodiments, a solid-liquid separation system includes: the filter cloth laying assembly, an assembly for carrying and moving the filter cylinder, a squeezing assembly, and an assembly for laying a filter cloth, unloading materials and rolling up a filter cloth. The squeezing assembly is located above the filter cylinder, and the assembly for carrying and moving the filter cylinder is located below the filter cylinder. In a horizontal direction, the filter cloth laying assembly and the squeezing assembly are arranged side by side. The filter cylinder is configured to move back and forth below the filter cloth laying assembly and the squeezing assembly through the assembly for carrying and moving the filter cylinder.

On the other hand, the solid-liquid separation system further includes an assembly for laying a filter cloth, unloading materials and rolling up a filter cloth.

The assembly for laying a filter cloth, unloading materials and rolling up a filter cloth includes an unloading component, a filter cloth arranging component and a filter cloth rolling and laying component which are connected in sequence. The unloading component is used to unload the dry materials after being squeezed from the filter cloth, the filter cloth arranging component is used to flatten the filter cloth being removed from the dry material, and the filter cloth rolling and laying component is used to roll up the filter cloth and lay the filter cloth.

The unloading component includes a driving guide roller, a material discharging conveyor tangent to the driving guide roller.

The filter cloth arranging component includes a first free guide roller, a second free guide roller and a third free guide roller, which is in a V shape. A wrinkle removing roller is located between the second free guide roller at a bottom of the V shape and the first free guide roller on one side. A scrubber located between the second free guide roller at the bottom of the V shape and the third free guide roller on the other side.

Compared with the third free guide roller, the first free guide roller is closer to the unloading component.

The filter cloth rolling and laying component includes a corrector and a cloth roller, and the corrector is located between the filter cloth arranging component and the cloth roller.

Preferably, the cloth roller is located below the filter cloth arranging component.

In some embodiments, the unloading component is arranged on an upper of the whole apparatus, the filter cloth arranging component is arranged on a middle of the whole apparatus; and the filter cloth rolling and laying component is arranged below the middle of the whole apparatus.

By arranging three assemblies with the above functions on the upper, middle and lower of the apparatus, dry material is removed from the filter cloth, and the filter cloth is flattened, rolled up and laid. The apparatus makes full use of the multi-dimensional space, has a compact structure and occupies a small space. The filter cloth is effectively cleaned, and the efficiency of unloading materials and cleaning the filter cloth is improved.

In some embodiments, the unloading component also includes: an expansion plate for reducing wrinkles of the filter cloth and a smooth conveying plate. In a movement direction of the filter cloth in rolling up the filter cloth, the expansion plate, the smooth conveying plate and the driving guide roller are arranged in sequence. A surface of the expansion plate being contact with the filter cloth is provided with protrusions, and a cross section of each of the protrusions is in “>”-shaped.

When the filter cloth is rolled up and materials is removed, the wrinkled filter cloth first passes through an apex of each of the protrusions being in “>”-shaped and is unfolded toward both sides of the movement direction along inclined edges of the protrusions. It plays a role in reducing wrinkles of the filter cloth.

In some embodiments, the wrinkle removing roller in the filter cloth arranging component is in a working position and an idle position. When the filter cloth is rolled up and materials is removed, the wrinkle removing roller is in the working position, and the filter cloth is tensioned to remove the wrinkles. When the filter cloth is laid, the wrinkle removing roller is in the idle position, and the wrinkle removing roller is not in contact with the filter cloth.

The wrinkle removing roller is switched on two positions. In laying the filter cloth, the wrinkle removing roller is not in contact with the filter cloth, so the laying speed of the filter cloth is affected. In rolling up the filter cloth, the wrinkle removing roller is in contact with the filter cloth, so as to tension the filter cloth to remove the wrinkles of the filter cloth.

There is at least one wrinkle removing roller. Preferably, there are two or more wrinkle removing rollers.

The wrinkle removing roller is in contact with the filter cloth and tensions the filter cloth between the first free guide roller and the second free guide roller, thereby removing wrinkles.

In some embodiments, the scrubber of the filter cloth arranging component includes a high-pressure sprayer, a rotating brush and a flushing back plate. The high-pressure sprayer and the rotating brush are on a same side of the filter cloth, opposite to the flushing back plate. The flushing back plate is located on the other side of the filter cloth. Multiple high-pressure sprayer and rotating brushes in each of scrubbers are arranged at intervals.

Multiple scrubbers are provided, and the flushing back plates of two adjacent scrubbers may respectively be located on both sides of the filter cloth, or on a same side of the filter cloth.

In some embodiments, the filter cloth arranging component also includes a water collecting and draining member, which is located below and on the side of the V shape consisted by three free guide rollers, the wrinkle removing roller and the scrubber, for collecting all the rinse water and discharging it from a drainage port.

When the filter cloth is rolled up and materials is removed, the filter cloth first passes through the wrinkle removing roller and then passes through the scrubber in the movement direction of the filter cloth.

The assembly for laying a filter cloth, unloading materials and rolling up a filter cloth of the present application is compact and occupies small space, the filter cloth is effectively cleaned, and it is improved on removing materials and cleaning the filter cloth.

In some embodiments, an assembly for carrying and moving the filter cylinder includes a working position A and a working position B, and the filter cylinder is configured to reciprocates between the working position A and the working position B.

In some embodiments, the filter cylinder includes a cylinder body and a movable bottom plate located in the cylinder body. The cylinder body is a hollow cubic structure of which sidewalls are provided with water outlet holes. A top of the cylinder body is open. The movable bottom plate is matched with the cross section of an inner cavity of the cylinder body and can move up and down along the cylinder body, and a bottom of the cylinder body is open.

In some embodiments, the squeezing assembly includes a hydraulic device and a squeezing plate, and the hydraulic device and the squeezing plate are arranged above the cylinder body at the working position B. The hydraulic device drives the squeezing plate to squeeze downward from the opening of the top of the cylinder body.

In some embodiments, the first frame is arranged at working position A, the above assembly for laying a filter cloth, unloading materials and rolling up a filter cloth is located on one side of the working position A, and the above filter cloth laying assembly is arranged on the first frame. At working position A, multiple layers of materials to be treated are laid in the filter cylinder.

In some embodiments, two first fixed guide rails are arranged at a working position A, and parallel to each other and extended toward a working position B. A lifter is located between the two first fixed guide rails and can support the movable bottom plate. Two movable guide rails are arranged at a working position B, and parallel to each other. The movable guide rails are capable of being raised and lowered. The two movable guide rails are respectively combined with the two first fixed guide rails and are respectively in the same straight lines. The pressure-bearing member is located between the two movable guide rails.

The above assembly for laying a filter cloth, unloading materials and rolling up a filter cloth is located on one side of the working position A, and cooperates with the filter cloth laying assembly to roll up and lay the filter cloth.

In some embodiments, the assembly for carrying and moving the filter cylinder includes two first fixed guide rails located at the working position A, and the two first fixed guide rails are parallel to each other.

One pair or two pairs of movable guide rails, a second fixed guide rail and a pressure-bearing member are located at the working position B, wherein each pair of movable guide rails are parallel to each other. When two pairs of movable guide rails are provided, the two pairs of movable guide rails are perpendicular to each other, and the first fixed guide rails of the working position A and the one pair of movable guide rails of the working position B are respectively on a same straight line. The second fixed guide rail is located in a space between the first fixed guide rail and an end of the movable guide rail adjacent to the first fixed guide rail. The pressure-bearing member is located between one or two pairs of movable guide rails.

The second fixed guide rail is provided to connect with the first fixed guide rail and the movable guide rail.

An upper end of the pressure-bearing member is a flat plate, which is used to bear the pressure of the squeezing process. When the filter cylinder is located on the first fixed guide rails, the upper end of the pressure-bearing member is lower than a bottom end of the filter cylinder.

The movable guide rails are configured to move up and down. When the filter cylinder moves to the working position B, the movable guide rails moves downward, and the pressure-bearing member supports the filter cylinder and bears the pressure of the squeezing process. When the movable guide rails rise to a highest position, the upper surfaces of the movable guide rails is on a same horizontal plane as the upper surfaces of the first fixed guide rails. When the movable guide rails descend to a lowest position, the upper surfaces of the movable guide rails are lower than the upper surface of the pressure-bearing member.

Preferably, the upper surface of the second fixed guide rail and the upper surface of the first fixed guide rail are located on a same horizontal plane.

In some embodiments, the working position A of the assembly for carrying and moving the filter cylinder, the filter cloth laying assembly, the assembly for laying a filter cloth, unloading materials and rolling up a filter cloth are combined into a set of equipment; more than two sets of the equipments are arranged around the working position B and the squeezing assembly.

A configuration of the working position B is substantially same as a cross-section of the filter cylinder, being square. Two sets of the equipments are arranged on both sides of the working position B and the squeezing assembly, and the solid-liquid separation system is in a straight line as a whole in the horizontal direction; or, the solid-liquid separation system is in an L shape as a whole in the horizontal direction.

In some embodiments, the solid-liquid separation system includes three sets of the equipments. Three sets of the equipments are arranged around the working position B and the squeezing assembly, and on three sides of the working position B. The solid-liquid separation system as a whole is in T-shaped.

In some embodiments, the solid-liquid separation system includes four sets of the equipments. Four sets of the equipments are arranged around the working position B and the squeezing assembly, and on four sides of the working position B. The solid-liquid separation system as a whole is in two straight lines perpendicular to each other.

In the solid-liquid separation system, by arranging multiple of the working positions A, corresponding filter cloth laying assemblies, and the apparatuses for laying a filter cloth, unloading materials and rolling up a filter cloth, the processes of laying and squeezing materials, unloading materials and cleaning the filter cloth are repeatedly and alternately carried out. So, it can be not only improved on the dehydration efficiency of the materials, but also reducing the cost.

A solid-liquid separation system of the present application and the structure and function of each component are further explained below with reference to the accompanying drawings.

A solid-liquid separation system includes a filter cylinder 1, an assembly 2 for carrying and moving the filter cylinder, a filter cloth laying assembly 3, a squeezing assembly 4, and an apparatus 5 for laying a filter cloth, unloading materials and rolling up a filter cloth.

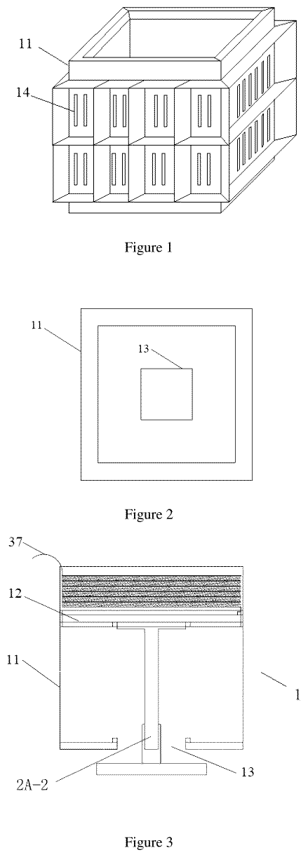

As shown in FIGS. 1, 2 and 3, the filter cylinder 1 includes a cylinder body 11 and a movable bottom plate 12 located in the cylinder body 11. The cylinder body 11 is a hollow cubic structure of which four sidewalls are provided with water outlet holes 14. A top of the cylinder body 11 is open, and a lower opening 13 is provided in a middle of a bottom of the cylinder body 11. The lower opening 13 is smaller than a cross section of the cylinder body 11. The movable bottom plate 12 is matched with the cross section of an inner cavity of the cylinder body 11 and can move up and down along the cylinder body 11. Wheel sets are arranged on both sides of the bottom of the cylinder body 11 as moving devices.

As shown in FIG. 7, the assembly 2 for carrying and moving the filter cylinder includes a working position A and a working position B. The filter cylinder 1 can reciprocate between the working position A and the working position B through a moving device.

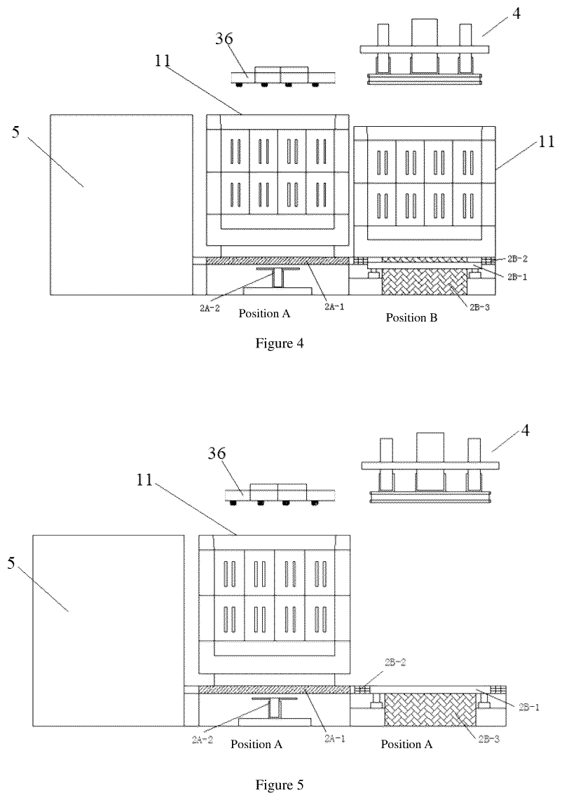

To further understand the status of the filter cylinder 1 in the working position A and the working position B, FIG. 4 is shown a schematic diagram of the filter cylinder in the working position A and the working position B. Since there is only one filter cylinder 1, the filter cylinder 1 is not actually located in the working position A and the working position B at the same time, but is located in the working position A or the working position B according to the process requirements.

The working position A of the assembly 2 for carrying and moving the filter cylinder includes two first fixed guide rails 2A-1 being parallel to each other and extended toward the working position B. As shown in FIG. 5, the first fixed guide rails 2A-1 is configured to carry the filter cylinder located at the working position A.

The working position A also includes a lifter 2A-2 which can be raised and lowered. The lifter 2A-2 is located between the two first fixed guide rails 2A-1. The lifter 2A-2 can be extended upward and extend into the cylinder body 11 through the lower opening 13 at the bottom of the cylinder body 11 to support the movable bottom plate 12 in the cylinder body 11. As the lifter 2A-2 is extended or contracted, the movable bottom plate 12 can be moved upward or downward. When the lifter 2A-2 is in a fully retracted state, an upper end of the lifter is lower than an upper end of the first fixed guide rails 2A-1.

The working position B of the of the assembly 2 for carrying and moving the filter cylinder includes two movable guide rails 2B-1 and a pressure-bearing member 2B-3. Every two movable guide rails 2B-1 are parallel to each other, and the two movable guide rails 2B-1 are respectively combined with the two first fixed guide rails 2A-1 and are respectively in the same straight lines. The pressure-bearing member 2B-3 is located between two guide rails of the movable guide rails 2B-1.

An upper end of the pressure-bearing member 2B-3 is a plane. When the filter cylinder 1 is located on the first fixed guide rails 2A-1, the upper end of the pressure-bearing member 2B-3 is lower than the bottom of the filter cylinder 1.

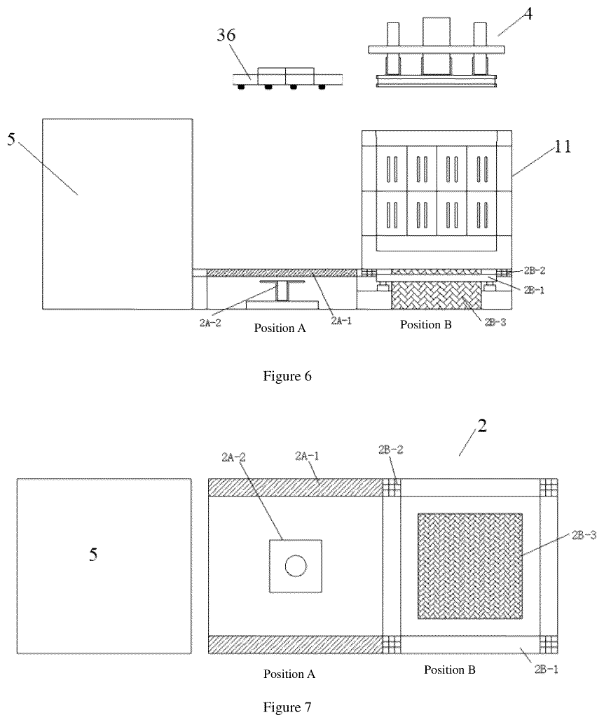

The movable guide rails 2B-1 are capable of being raised and lowered. As shown in FIG. 5. when the movable guide rails 2B-1 move upward to an extreme position, the upper ends of the movable guide rails flush with the upper end of the first fixed guide rails 2A-1, the cylinder body 11 is moved from the working position A to the working position B, or from the working position B to the working position A. As shown in FIG. 6, when the movable guide rails 2B-1 are descended to the lowest position, the upper ends of the movable guide rails are lower than the upper end of the pressure-bearing member 2B-3. At this time, the pressure-bearing member 2B-3 is used to support the cylinder body 11.

The filter cylinder 1 is configured to reciprocate between the working position A and the working position B by cooperating the wheel sets arranged on both sides of the bottom of the cylinder body 11 with the first fixed guide rails 2A-1 of the working position A and the movable guide rails 2B-1 of the working position B of assembly 2 for carrying and moving the filter cylinder. The guide rail structure of the first fixed guide rails 2A-1 is consistent with that of the movable guide rails 2B-1.

In other embodiments, the working position B also includes a second fixed guide rail 2B-2. As shown in FIG. 7, the second fixed guide rail 2B-2 is located between the first fixed guide rail 2A-1 and the movable guide rail 2B-1. The upper end of the second fixed guide rail 2B-2 is flush with the upper end of the first fixed guide rail 2A-1, and is used to connect the first fixed guide rail 2A-1 and the movable guide rail 2B-1.

The guide rail structures of the first fixed guide rails 2A-1, the second fixed guide rail 2B-2, and the movable guide rails 2B-1 are consistent, and can be assembled into a strip structure with a square cross-section.

In one embodiment, as shown in FIG. 14, both the first fixed guide rail 2A-1 and the movable guide rail 2B-1 are configured as groove-shaped guide rails with a limiting function. Thus, when the filter cylinder 1 moves from the working position A to the working position B of assembly 2 for carrying and moving the filter cylinder, the wheel sets arranged on both sides of the bottom of the cylinder body 11 respectively travel on two groove-shaped guide rails, and rollers of the wheel sets at the bottom of the cylinder body 11 are located in grooves of the groove-shaped guide rails to prevent them from falling off the guide rails.

In other embodiments, roller sets are arranged on both sides of the bottom of the cylinder body 11. Each of the roller sets includes a first roller and a second roller, a rotating axis of the first roller is parallel to the bottom of the filter cylinder, the second roller is located below the first roller, and a rotating axis of the second roller is perpendicular to the bottom of the filter cylinder. The second roller is located at a side of the first roller close to a center of the filter cylinder. The first roller is in contact with the top of the guide rail, and the second roller also includes a limiting structure that is in contact with an inner side of the guide rail to prevent it from falling off the rail. Alternatively, the roller set on each side of the bottom of the cylinder body 11 includes a first roller in contact with the top of the guide rail and a second roller in contact with the inner side of the guide rail, so that the roller set can be carried by and move on the guide rail and prevented from falling off the guide rail.

The filter cloth laying assembly 3 includes a first frame 31, and a laying and folding component and a dispensing component 36 installed on the first frame 31.

The first frame 31 is vertically arranged on left side and right side of the working position A of the assembly 2 for carrying and moving the filter cylinder, and a top of the first frame 31 is higher than the cylinder body 11. The cylinder body 11 can pass through the rear side of the first frame 31 and move from the working position A to the working position B.

The laying and folding component and the dispensing component 36 are located at the top of the cylinder body 11 of the working position A of the assembly 2 for carrying and moving the filter cylinder. The dispensing component 36 is fixed to the top of the first frame 31 and is located above the cylinder body 11 of the working position A.

The dispensing component 36 is composed of one or more spray nozzles. Preferably, the spray nozzle is a shape of circular, rectangular or elliptical, or a duckbill-shape. In this embodiment, the dispensing component 36 is composed of a plurality of circular spray nozzles.

The laying and folding component includes a telescopic pressing plate 32, a front cloth pressing member 34, a rear cloth pressing member 35 and a cloth folding and scraping member 33. The first frame 31 includes middle cross beams extending along the front and rear directions of the cylinder body 11. The middle cross beams are arranged in pairs on the left side and the right side of the cylinder body 11. A front end of the middle cross beam is provided with a front cloth pressing member 34, and a rear end of the middle cross beam is provided with a rear cloth pressing member 35.

As shown in FIGS. 11 and 12, the front cloth pressing member 34 includes a retractable cloth pressing rod 341 and a first support seat 342 being capable of moving up and down. The front cloth pressing members 34 are arranged in pairs at the front ends of the middle cross beams on the left side and the right side, and is respectively located on a left side and a right side of a front end of the top of the cylinder body 11. The cloth pressing rod 341 of the front cloth pressing member can be extended and retracted along the left-right direction of the cylinder body 11.

As shown in FIGS. 11 and 12, the rear cloth pressing member 35 also includes a retractable cloth pressing rod and a second support seat 352 being capable of moving up and down. The rear cloth pressing members 35 are arranged in pairs at the rear ends of the middle cross beams on the left side and the right side, and is respectively located on a left side and a right side of the rear end of the top of the cylinder body 11. The cloth pressing rod 351 of the rear cloth pressing member can be extended and retracted along the left-right direction of the cylinder body 11.

The paired cloth pressing rods 341 of the front cloth pressing member and the paired cloth pressing rods 351 of the rear cloth pressing member located on the left side and the right side of the cylinder body 11 can be extended toward the cloth pressing rods on the opposite side from a contracted state. The ends of the extended cloth pressing rods do not touch each other, and are hung at the top of the cylinder body 11.

An upper of the telescopic pressing plate 32 is fixed to the top of the first frame 31. The telescopic pressing plate 32 is hung above the cylinder body 11, is located right above the front cloth pressing member 34, and can be stretched out and drawn back up and down. A lower of the telescopic pressing plate 32 has a first groove, a lower of the first groove is open, and an opening is set on a left end and a right end of the groove. The two cloth pressing rods of the front cloth pressing members 34 can be respectively inserted into the first groove from the openings of the left end and the right end of the first groove, and can be pulled out of the first groove from the bottom opening of the first groove to be separated from the telescopic pressing plate 32.

The cloth folding and scraping member 33 includes a push plate 331, a third support seat 332 and a movable slide rail 333. The movable slide rails 333 on a left side and a right side are respectively arranged on the middle cross beams on the left side and the right side, and are located at a side outward on the first support seat 342 of the front cloth pressing member 34. The two third support seats 332 are respectively located on the movable slide rails 333 on a left side and a right side, and the movable slide rails 333 are used for supporting the third support seats 332. Tops of the two third support seats 332 are commonly connected to and support the push plate 331. The push plate 331 is configured to cross over the top of the cylinder body 11. The third support seat 332 drives the push plate 331 to reciprocate along the movable slide rail 333 between the front end and the rear end of the top of the cylinder body 11.

A second groove is formed at a lower portion of the push plate 331. The second groove is open at a lower, and an opening is set at a left end and a right end. Two cloth pressing rods of the rear cloth pressing member 35 can be respectively inserted into the second groove from the openings of the left end and the right end of the second groove. The two cloth pressing rods can be pulled out of the opening on the lower of the second groove and separated from the push plate 331 when the second support seat 352 of the rear cloth pressing member 35 descends downward.

The push plate 331 of the cloth folding and scraping member 33 has a width, and the width of the push plate 331 is defined as a dimension of the push plate 331 along a front-rear direction of the cylinder body 11.

The push plate 331 has a certain width, and the push plate 331 can be defined as a front part and a rear part along the width direction. The front part of the push plate 331 is connected to the third support seats 332 on the left side and the right side, and a lower of the rear part of the push plate 331 is provided with a second groove. In this way, the two cloth pressing rods of the rear cloth pressing member 35 are respectively inserted into the second groove from openings of a left end and a right end of the second groove, so they do not touch the third supporting seat 332 of the cloth folding and scraping member 33.

When the telescopic pressing plate 32 is in an upwardly retracted state and the front cloth pressing member 34 is in a downwardly moved state, a distance between the telescopic pressing plate 32 and the front cloth pressing member 34 is greater than the thickness of the push plate 331 of the cloth folding and scraping member 33, so the push plate 331 can pass through the space between the telescopic pressing plate 32 and the front cloth pressing member 34. The thickness of the push plate 331 is defined as a dimension of the push plate 331 in an up-down direction.

In other embodiments, the cloth folding and scraping member 33 also includes a push plate 331, a third support seat 332 and a movable slide rail 333. However, the movable slide rails 333 on the left side and the right side are arranged on a top crossbeam of the first frame 31, and the top crossbeam is located above the cylinder body 11.

Two third support seats 332 are respectively located on the movable slide rails 333 on the left side and the right side, and the third support seats 332 are hung on the movable slide rails 333. The bottoms of the two third support seats 332 are commonly connected with the push plate 331 for supporting the push plate, and the push plate 331 is configured to span over the top of the cylinder body 11. The third support seats 332 drive the push plate 331 to reciprocate along the movable slide rails 333 between the front end and the rear end of the top of the cylinder body 11.

A second groove is formed at a lower of the push plate 331. The second groove is open at the bottom and at both left end and right end. Two cloth pressing rods of the rear cloth pressing members 35 can be respectively inserted into the second groove from openings on the left end and the right end of the second groove, and can be disengaged from the second groove through the opening at the bottom to separate from the push plate 331 when the second support seats 352 of the rear cloth pressing members 35 move downwards.

The push plate 331 has a certain width, and the push plate 331 can be defined into a front part and a rear part along the width direction. The front part of the push plate 331 is connected to the third support seats 332 on the left side and the right side, and a lower of the rear part of the push plate 331 is provided with a second groove. In this way, the two cloth pressing rods of the rear cloth pressing member 35 are respectively inserted into the second groove from openings of a left end and a right end of the second groove, so they do not touch the third supporting seat 332 of the cloth folding and scraping member 33.

When the telescopic pressing plate 32 is in an upwardly retracted state and the front cloth pressing member 34 is in a downwardly moved state, a distance between the telescopic pressing plate 32 and the front cloth pressing member 34 is greater than the thickness of the push plate 331 of the cloth folding and scraping member 33, so the push plate 331 can pass through the space between the telescopic pressing plate 32 and the front cloth pressing member 34. The thickness of the push plate 331 is defined as a dimension of the push plate 331 in an up-down direction.

The squeezing assembly 4 includes a second frame, a hydraulic device 41 and a squeezing plate 44.

The second frame is vertically arranged on the left side and the right side of the working position B of the assembly 2 for carrying and moving the filter cylinder, and a top of the second frame is higher than the cylinder body 11. The cylinder body 11 can pass through the front side of the second frame and move from the working position B to the working position A.

The hydraulic device 41 and the squeezing plate 44 are arranged above the cylinder body 11 at the working position B, and the hydraulic device 41 is fixed on the second frame. The hydraulic device 41 has a telescopic rod that can be stretched and retracted up and down, and a bottom of the telescopic rod is connected with the squeezing plate 44. An area of the squeezing plate 44 is matched a cross-section of the inner cavity of the cylinder body 11. The dimension of the squeezing plate 44 is slightly smaller than the cross-section of the inner cavity of the cylinder body 11. The squeezing plate 44 can move downward from an opening on a top of the cylinder body 11.

In this embodiment, the pressure-bearing member 2B-3 is located between two movable guide rails 2B-1. When the movable guide rails 2B-1 descends to the lowest position, its top is lower than a top of the pressure-bearing member 2B-3. At this time, the pressure-bearing member 2B-3 is used for supporting the cylinder body 11. When the hydraulic device 41 drives the squeezing plate 44 to press downward, the pressure-bearing member 2B-3 is subjected to the pressure. The pressure-bearing member 2B-3 is slightly smaller than the bottom of the cylinder body, that is, lengths of sides of the pressure-bearing member 2B-3 are smaller than lengths of four sides of the cylinder body. The pressure-bearing member 2B-3 is located in a space enclosed by the cylinder walls at the bottom of the cylinder body, so that the pressure-bearing member 2B-3 does not transfer force to the four walls of the cylinder body during squeezing.

A left end and a right end of the pressure-bearing member 2B-3 are fixedly connected with the second frame at a position below the movable guide rails 2B-1, which does not hinder the movable guide rails 2B-1 from descending. Therefore, when the movable guide rails 2B-1 descend to the lowest position, the pressure-bearing member 2B-3 is use to support the cylinder body. When he hydraulic device 41 drives the squeezing plate 44 to squeeze downward, the pressure-bearing member 2B-3 is subject to the pressure force and transfers the force to the second frame.

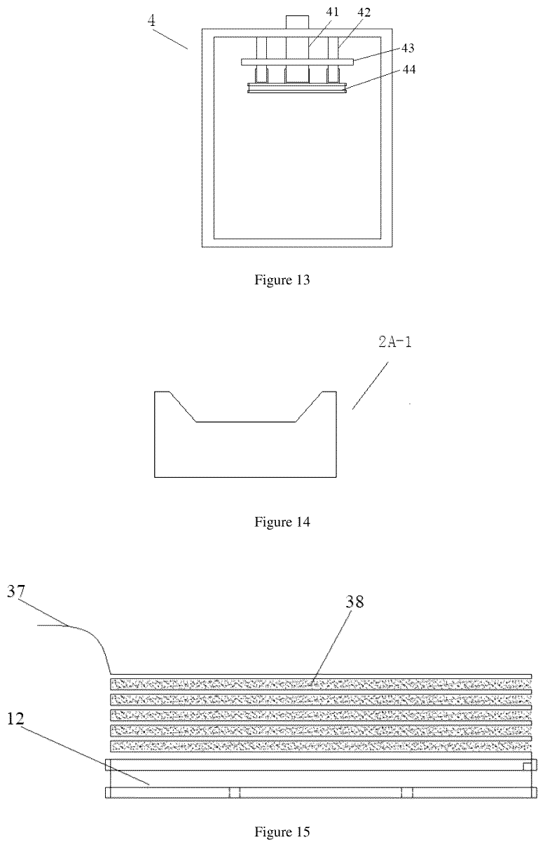

In other embodiments, as shown in FIG. 13, the squeezing assembly 4 further includes a balancing rod 42 and a limiting plate 43. The limiting plate 43 is arranged parallel to the squeezing plate 44 and is located above the squeezing plate 44. Holes are formed at a center and four corners of the limiting plate 43. The hydraulic device 41 and the balancing rod 42 each include a fixed upper portion and a retractable lower portion. Four balancing rods 42 are vertically arranged, and the upper portions respectively pass through the holes at the four corners of the limiting plate 43 and are fixed to the limiting plate 43. The lower portions of the balancing rods 42 are connected with the squeezing plate 44. The upper portion of the hydraulic device 41 passes through the hole at the center of the limiting plate 43 and is fixed to the limiting plate 43, and the lower portion of the hydraulic device 41 is connected with the squeezing plate 44.

The apparatus 5 for laying a filter cloth, unloading materials and rolling up a filter cloth is located at one side of the working position A, and cooperates with the filter cloth laying assembly 3 to roll up and lay the filter cloth 37. In this embodiment, the apparatus 5 for laying a filter cloth, unloading materials and rolling up a filter cloth is located at the front side of the cylinder body 11 of the working position A.

The apparatus 5 for laying a filter cloth, unloading materials and rolling up a filter cloth comprises a unloading component, a filter cloth arranging component and a filter cloth rolling and laying component which are connected in sequence.

The unloading component is arranged on the upper of the apparatus 5 for laying a filter cloth, unloading materials and rolling up a filter cloth.

The unloading component includes a driving guide roller 53, a material discharging conveyor 54 tangent to the driving guide roller 53, an expansion plate 51 and a smooth conveying plate 52. In a movement direction of the filter cloth 37 in rolling up the filter cloth 37, the expansion plate 51, the smooth conveying plate 52 and the driving guide roller 53 are arranged in sequence.

The expansion plate 51 is provided with protrusions. When the filter cloth 37 passes through the expansion plate 51, the width of the filter cloth is expanded under the action of the protrusions, thereby reducing wrinkles and allowing material to be laid loosely on the surface of the filter cloth 37.

The filter cloth arranging component includes three free guide rollers arranged in a V shape, namely a first free guide roller 55, a second free guide roller 57 and a third free guide roller 59; a wrinkle removing roller 56 located between the second free guide roller 57 at the bottom of the V shape and the first free guide roller 55 on one side; and a scrubber 58 located between the second free guide roller 57 at the bottom of the V shape and the third free guide roller 59 on the other side.

There may be one or more wrinkle removing rollers 56. In this embodiment, there are two wrinkle removing rollers 56.

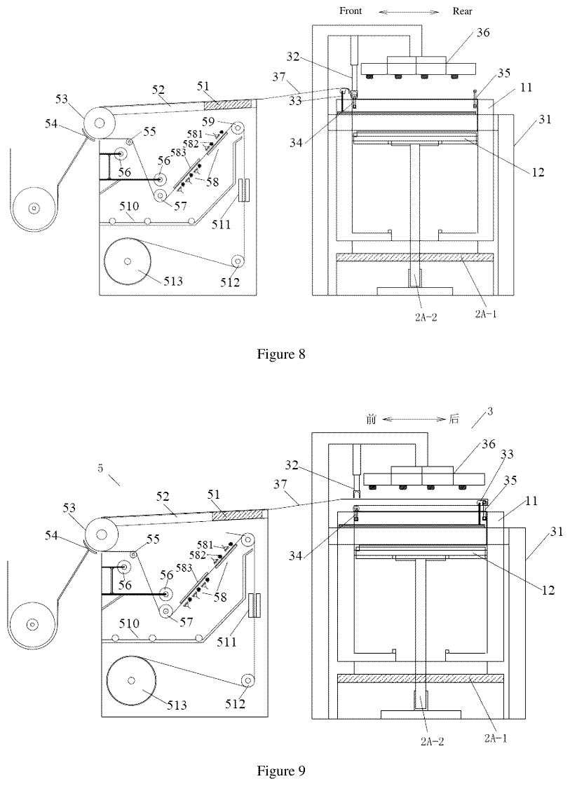

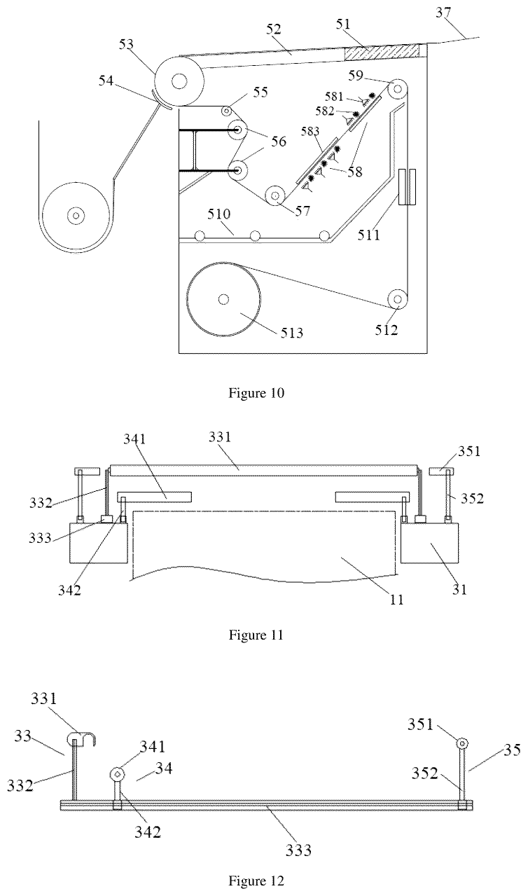

The wrinkle removing roller 56 in the filter cloth arranging component is in a working position and an idle position. The position of the wrinkle removing roller 56 is changed by stretching and retracting a suspension being used to support the wrinkle removing roller 56, thereby forming the working position and the idle position of the wrinkle removing roller 56. When the filter cloth is rolled up and material is unloaded, as shown in FIG. 10, the wrinkle removing rollers 56 are in the working position. The two wrinkle removing rollers 56 are in contact with two surfaces of the filter cloth 37 respectively, and pull the filter cloth 37 between the first free guide roller 55 and the second free guide roller 57 in two opposite directions to tension it to remove the wrinkles of the filter cloth. When the filter cloth is laid, as shown in FIGS. 8 and 9, the wrinkle removing rollers 56 are in the idle position, and the wrinkle removing rollers 56 does not contact the filter cloth 37. The filter cloth 37 is directly driven to move on the first free guide roller 55 and the second free guide roller 57 to reduce the resistance.

Multiple scrubbers 58 are provided, each of scrubbers 58 includes a high-pressure sprayer 581, a rotating brush 582 and a flushing back plate 583. The high-pressure sprayer 581 and the rotating brush 582 are on the same side of the filter cloth, opposite to the flushing back plate 583. The flushing back plate 573 is located on the other side of the filter cloth 37. The filter cloth 37 passes through between the high-pressure sprayer 581 and the flushing back plate 583. Multiple high-pressure sprayer 581 and rotating brushes 582 in each of scrubbers 58 are arranged at intervals, that is, one rotating brush 582 is arranged between two high-pressure sprayer 581, and one high-pressure sprayer 581 is arranged between two rotating brushes 582. The flushing back plates 583 of two adjacent scrubbers 58 may respectively be located on both sides of the filter cloth, or on the same side of the filter cloth. In this embodiment, the flushing back plates 583 of two adjacent scrubbers 57 are located on both sides of the filter cloth respectively.

The filter cloth arranging component also includes a water collecting and draining member 510, which is located below and on the side of the V shape consisted by the three free guide rollers, the wrinkle removing rollers 56 and the scrubber 57, for collecting all the rinse water and discharging it from a drainage port.

The filter cloth rolling and laying component comprises a corrector 511 and a cloth roller 513 which are arranged below the middle of the apparatus 5 for laying a filter cloth, unloading materials and rolling up a filter cloth, and the corrector 511 is located between the filter cloth arranging component and the cloth roller 513. In this embodiment, a fourth free guide roller 512 is arranged between the corrector 511 and the cloth roller 513.

During operation, the cylinder body 11 is located on the working position A of the assembly 2 for carrying and moving the filter cylinder, and the lifter 2A-2 is stretched upward from the opening 13 at the bottom of the cylinder body 11 into the cylinder body 11 to support the movable bottom plate 12 in the cylinder body 11 and used to lift the movable bottom plate 12 to the top of the cylinder body 11.

The filter cloth 37 is rolled up on the cloth roller 513, and one end of the filter cloth 37 is located in the cloth roller. The filter cloth on the cloth roller passes through the apparatus 5 for laying a filter cloth, unloading materials and rolling up a filter cloth, the other end of the filter cloth 37 is fixed to the rear end of the movable bottom plate 12, and the filter cloth 37 is laid on the movable bottom plate 12 located at the top of the cylinder body 11, which is the initial state. The other end of the filter cloth can be fixed to the front end or the rear end of the movable bottom plate 12. In this embodiment, the other end of the filter cloth is fixed to the rear end of the movable bottom plate 12 for example.

In a process of laying the filter cloth, the driving guide roller 53 and the cloth roller 513 are driven by the motor to convey the filter cloth, for conveying the clean and flat filter cloth to the filter cloth laying assembly 3, so as to ensure the high consistency of the process of the overall equipment. As shown in FIGS. 8 and 9, in a process of laying the filter cloth, the wrinkle removing rollers 56 are in an idle position, and the wrinkle removing rollers 56 are not in contact with the filter cloth 37. The filter cloth 37 is directly conveyed on the first free guide roller 55 and the second free guide roller 57 to reduce the resistance.

The filter cloth laying assembly 3 performs the operations of laying-folding the filter cloth and spraying-coating material. The process of laying-folding the filter cloth and spraying-coating material is as follows.

The telescopic pressing plate 32 located above the front end of the cylinder body 11 is stretched downward to the top of the cylinder body 11 and presses the filter cloth 37. The dispensing component 36 sprays material onto the surface of the filter cloth 37. As shown in FIG. 8, the cloth pressing rod 341 of the front cloth pressing member is inserted into the first groove of the telescopic pressing plate 32, and the first support seat 342 of the front cloth pressing member 34 moves downward to make the cloth pressing rod 341 of the front cloth pressing member move downward to the top of the cylinder body 11. The cloth pressing rod 341 of the front cloth pressing member replaces the telescopic pressing plate 32 to press the filter cloth 37, the telescopic pressing plate 32 retracts upward to the original position, and the cloth pressing rod 341 of the front cloth pressing member falls out of the first groove from the opening of the bottom of the first groove of the telescopic pressing plate 32 and is separated from the telescopic pressing plate 32. At this time, the top of the cloth folding and scraping member 33 is covered with filter cloth 37 and the vertical position of the cloth folding and scraping member 33 is higher than the cloth pressing rod 341 of the front cloth pressing member. When the apparatus 5 for laying a filter cloth, unloading materials and rolling up a filter cloth carries out laying the filter cloth, the cloth folding and scraping 33 pushes the filter cloth 37 from the front end to the rear end of the cylinder body 11. The filter cloth without material is driven by the cloth folding and scraping member 33 to be released from the cloth roller 513 and pulled out of the apparatus 5 for laying a filter cloth, unloading materials and rolling up a filter cloth to cover the above mentioned sprayed material. The material sprayed on the surface of the filter cloth 37 is evenly distributed between the upper filter cloth and the lower filter cloth in the process of pushing the filter cloth 37 by the cloth folding and scraping member 33. As shown in FIG. 9, after the cloth folding and scraping member 33 reaches the rear end of the cylinder body 11, the cloth pressing rods 351 of the rear cloth pressing members are inserted into the second groove of the push plate 331 of the cloth folding and scraping member 33 from the left side and the right side, and the second support seat 352 of the rear cloth pressing member 35 moves downward to drive the cloth pressing rod 351 of the rear cloth pressing member to move to the top of the cylinder body 11 to press the filter cloth 37 for replacing the cloth folding and scraping member. At this time, two cloth pressing rod of the rear cloth pressing member 35 falls out of the second groove from the opening of the bottom of the second groove and are separated from the push plate 331, and then the cloth folding and scraping member 33 returns to the original position. The cloth pressing rod 341 of the front cloth pressing member is retracted, and the first support seat 342 of the front cloth pressing member 34 moves upward and resets. The telescopic pressing plate 32 is stretched downward to the top of the cylinder body 11 and presses the filter cloth 37. The cloth pressing rod 351 of the rear cloth pressing member is retracted, and the second support seat 352 of the rear cloth pressing member 35 moves upward and resets. The lifter 2A-2 moves downward to cause the movable bottom plate 12 to move downward for a distance, and the distance is equal to the sum of the thicknesses of the two layers of filter cloth and the material layer. At this time, the upper layer of filter cloth 37 is flush with the top of the cylinder body 11, and one process of laying-folding the filter cloth and spraying-coating material is completed. the above-mentioned process of laying-folding the filter cloth and spraying-coating material is repeated, and material and the filter cloth are laid layer by layer in the cylinder body 11 in a stacked state. As shown in FIG. 15, two layers of the filter cloth are arranged between the two layers of material, and the material is evenly distributed between the upper layer and the lower layer of the filter cloth. The process of laying the filter cloth stops until it is completed to distribute material. At this time the lifter 2A-2 is completely retracted and out of the cylinder body 11.

The filter cylinder 1 is driven to move on the guide rail of the assembly 2 for carrying and moving the filter cylinder through the rollers sets on the bottom of the cylinder body 11 by a driving device, and the filter cylinder 1 is moved from the working position A to the working position B of the assembly 2 for carrying and moving the filter cylinder. The filter cylinder 1 is carried by the first fixed guide rails 2A-1 of the working position A and carried by the movable guide rails 2B-1 of the working position B.

When the movable guide rails 2B-1 of the working position B is descended and moves to the lowest position, the filter cylinder 1 moves downward accordingly. The pressure-bearing member 2B-3 of the working position B supports the bottom of the cylinder body 11 for lifting and carrying the filter cylinder 1.

The hydraulic device 41 of the squeezing assembly 4 above the working position B starts to work, and the squeezing plate 44 is driven to move downward into the cylinder body 11 from the top to squeeze the filter cloth and material in the cylinder 11. During the squeezing process, the pressure is increased or decreased according to a speed of filtering out the water, and maintained for a certain time until the squeezing process is completed.

The width of the filter cloth 37 is slightly larger than the length of the side of the inner cavity of the cylinder body 11. During squeezing, the squeezing plate 44 moves downward, and the edge of the filter cloth entering the cylinder body 11 is folded upward due to the squeezing effect. Since the filter cloth and the material therein are stacked layer by layer, the folded filter cloth fills the gap between the wall of the cylinder body and material to form a seal, and the wet material is sealed in the two layers of the filter cloth, so only water can pass through the pores of the filter cloth. The squeezed water flows out of the cylinder body 11 through the water outlet holes 1-4 on the four sides of the cylinder body 11.

After the squeezing process is completed, the squeezing plate 44 rises and is out of the cylinder body 11. The movable guide rails 2B-1 of the working position B rises to be flush with the upper end of the first fixed guide rails 2A-1 of the working position A, and the filter cylinder 1 leaves the pressure-bearing member 2B-3 and rises with the movable guide rails 2B-1. The filter cylinder 1 moves from the working position B to the working position A of the assembly 2 for carrying and moving the filter cylinder.

The lifter 2A-2 of the working position A moves upward, so that material and the filter cloth being in a stacked state rise to the top of the cylinder body 11 after being squeezed.

A process of unloading material and rolling the filter cloth is as follows. The cloth roller 513 and the driving guide roller 53 in the apparatus 5 for laying a filter cloth, unloading materials and rolling up a filter cloth are driven to rotate by a motor, to drive the filter cloth 37 to move and rolling up the filter cloth. The material being dehydrated is attached on the filter cloth 37, and moves off the filter cylinder 1 together with the filter cloth 37 and enters the apparatus 5 for laying a filter cloth, unloading materials and rolling up a filter cloth.

The filter cloth 37 is caused to wrinkle in the squeezing process. When the filter cloth is rolled up, the filter cloth is separated from material, flattened and rolled up through the unloading component, the filter cloth arranging component, and the filter cloth rolling and laying component in sequence.

When passing through the unloading component, the width of the filter cloth 37 is expanded under the action of the protrusions of the expansion plate 51 during passing through the expansion plate 51, thereby reducing wrinkles and allowing material to be loosely distributed on the surface of the filter cloth. The filter cloth easily passes through the smooth conveying plate 52 due to the smaller friction between the smooth conveying plate 52 and the filter cloth 37, and the tension is provided for rolling up the filter cloth. When the filter cloth 37 passes through the driving guide roller 53, material on the filter cloth is stripped off by the material discharging conveyor 54 and carried away through by a screw conveyor, so the process of unloading material is completed. As the filter cloth is rolled up and material is stripped off, the thickness of material and the filter cloth in the cylinder body 11 is decreased. The lifter 2A-2 of the working position A of the assembly 2 for carrying and moving the filter cylinder continues to move upward, and material and the filter cloth are always kept at the top of the cylinder body 11, so the unloading process is smoothly carried out.

Subsequently, the filter cloth 37 passes through the filter cloth arranging component. At this time, the wrinkle removing roller 56 is in the working position, and the wrinkle removing roller 56 rotates to remove wrinkles of the filter cloth 37. And then the scrubbers 57 flush the filter cloth 37.

Finally, the filter cloth 37 passes through the filter cloth rolling and laying component, and is rolled on the cloth roller 513 after passing through the corrector 511 and the fourth free guide roller 512. The corrector 511 corrects the position of the filter cloth to prevent it from deviating, so that the filter cloth is rolled on the cloth roller 513 to form a neat cloth roll.

The solid-liquid separation system of the present invention comprises a filter cylinder, a assembly for carrying and moving the filter cylinder, an apparatus for laying a filter cloth, a squeezing assembly, and an assembly for laying a filter cloth, unloading materials and rolling up a filter cloth. The filter cylinder is placed in the working position A of the assembly for carrying and moving the filter cylinder, the apparatus for laying a filter cloth is used to spray material on the filter cloth in the cylinder body, and the filter cloth is folded and material is sprayed again, repeating the processes until the laying process is completed. Material and the filter cloth are stacked in the cylinder body in a stacked state. During this process, the filter cloth is laid by the assembly for laying a filter cloth, unloading materials and rolling up a filter cloth, material is sprayed on the filter cloth, and then the filter cylinder is moved to the working position B of the assembly for carrying and moving the filter cylinder and the squeezing assembly is used to squeeze water out of material. After that, the filter cylinder is moved to the working position A, material is stripped off the filter cloth and filter cloth is rolled up by the assembly for laying a filter cloth, unloading materials and rolling up a filter cloth. In the method for uniform spray-coating, cumulatively laying and squeezing, the filter cloth is driven by the laying and folding component to fold back and forth and laid on the movable bottom plate, and the dispensing component sprays material from top to bottom onto the filter cloth. Material is evenly distributed between the upper filter cloth and the lower filter cloth. Two layers of filter cloth are sandwiched between two layers of material. Material is packed with the filter cloth and squeezed in the filter cylinder. Multi-layer stacked material can be squeezed by uniform, long-term and high-pressure squeezing force in the squeezing process, thereby improving the effect of laying the filter cloth and dehydrating.

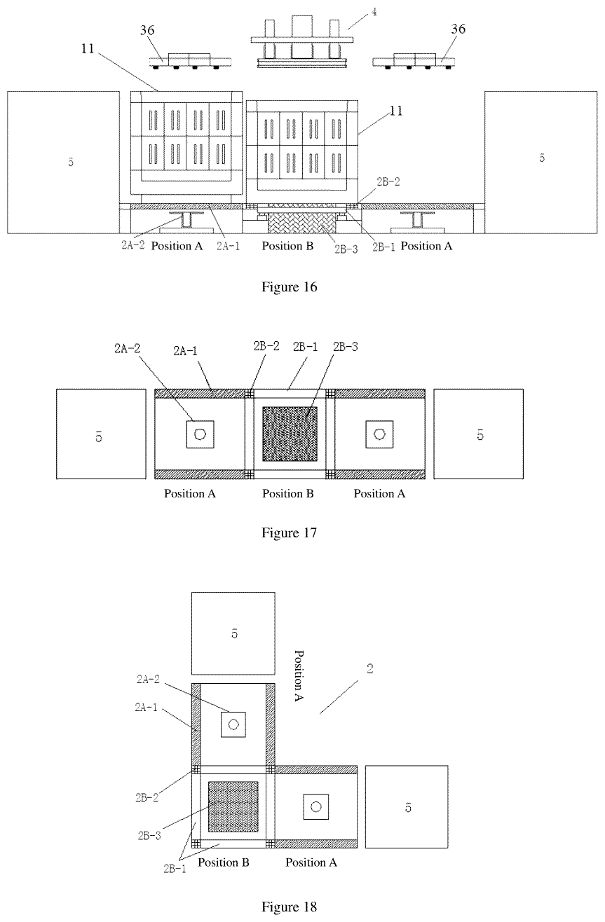

The filter cylinder, the working position A of the assembly for carrying and moving the filter cylinder, the apparatus for laying a filter cloth, the assembly for laying a filter cloth, unloading materials and rolling up a filter cloth are combined into a set of equipment. One, two, three or four sets of the equipments are arranged around the working position B and the squeezing assembly, as shown in FIGS. 16-20.

Taking an example that the solid-liquid separation system includes two sets of the equipments as shown in FIGS. 16 and 17, the two sets of the equipments are arranged on both sides of the working position B and the squeezing assembly, and the solid-liquid separation system as a whole is in a straight line. Or, as shown in FIG. 18, two sets of the equipments are on both sides of the working position B and the squeezing assembly, and the solid-liquid separation system as a whole is in L-shaped.

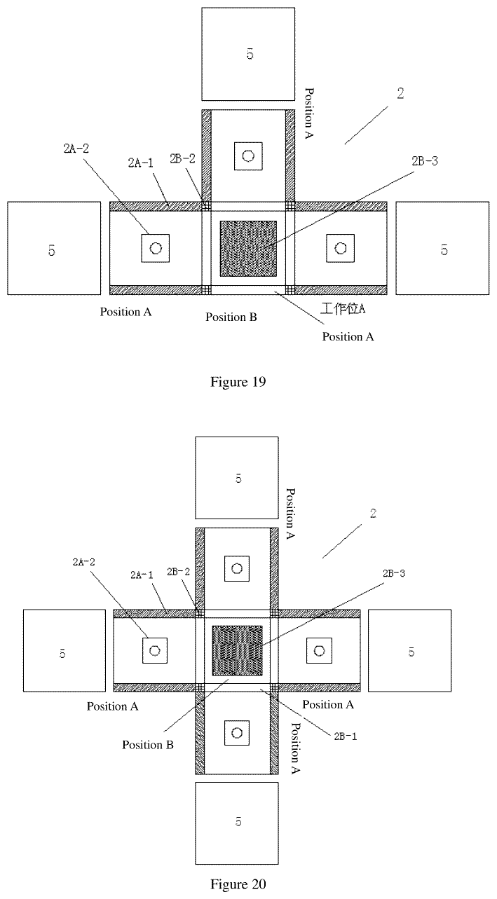

As an example that the solid-liquid separation system includes three sets of the equipments, as shown in FIG. 19, three sets of the equipments are arranged around the working position B and the squeezing assembly, and the solid-liquid separation system as a whole is in T-shaped.

As an example that the solid-liquid separation system includes four sets of the equipments, as shown in FIG. 20, four sets of the equipments are arranged around the working position B and the squeezing assembly, and the solid-liquid separation system as a whole is in two straight lines perpendicular to each other.

As shown in FIGS. 16-18, the solid-liquid separation system includes two sets of the equipments, a first set of the equipment and a second set of the equipment. The cylinder bodies 11 in two sets of the equipments are respectively located at two working positions A for laying the filter cloth and dispensing materials. After the above process is completed, the filter cylinder 1 of the first set of the equipment moves to the working position B, and the hydraulic device 41 of the squeezing assembly 4 above the working position B starts to drive the squeezing plate 44 to move downward and enter in the cylinder body 11 from the top to squeeze the filter cloth and materials in the cylinder body 11. During the squeezing process, the pressure is increased or decreased according to the drainage speed, and maintained for a certain time until the squeezing process is completed. After the squeezing process is completed, the filter cylinder 1 is moved to the original working position A from the working position B, and then the process of rolling up the filter cloth and unloading materials and the process of again laying the filter cloth and distributing materials are carried out. At this time, the filter cylinder 1 of the second set of the equipment is moved to the working position B, and the squeezing device 4 squeezes water out of the materials and the filter cloth in the filter cylinder until the squeezing process is completed. The filter cylinder 1 of the second set of the equipment is moved to the original working position A from the working position B, and then the process of rolling up the filter cloth and unloading materials and the process of again laying the filter cloth and distributing materials are carried out. At this time, the filter cylinder module 1 of the first set of the equipment is moved to the working position B, the squeezing device 4 squeezes water out of the materials and the filter cloth in the filter cylinder until the squeezing process is completed. The above steps are repeatedly carried out, the two sets of the equipments are in turn carried out the process of distributing materials and the squeezing process, so that treating time is effectively saved and the dehydration efficiency is improved.

When the solid-liquid separation system includes three sets of the equipments or four sets of the equipments, the operations refer to the processes of the above two sets of the equipments. The operations of the equipments are reasonably arranged, so that when the filter cylinder of one set of the equipment is in the squeezing process, other sets of the equipments are carried out the process of laying the filter cloth and distributing materials or the process of rolling up the filter cloth and unloading materials in this time. Thereby, it is not only improved on the dehydration efficiency, but also reduced in the overall cost.

As shown in FIG. 18, the solid-liquid separation system includes two sets of the equipments and the two sets of the equipments are located on two sides of the working position B not being opposite to each other, and two pairs of movable guide rails are arranged on the working position B. The four movable guide rails are arranged in a quadrilateral, and the pressure-bearing component is located at a center of the space enclosed by the four movable guide rails. Two pairs of the movable guide rails is configured to correspond to the first fixed guide rails of the two working positions A respectively to form guide rails for the filter cylinder 1 to reciprocate between the working position A and the working position B of the assembly 2 for carrying and moving the filter cylinder.

As shown in FIG. 19, the solid-liquid separation system includes three sets of the equipments. Two pairs of movable guide rails are arranged on the working position B. The four movable guide rails are arranged in a quadrilateral, and the pressure-bearing component is located at a center of the space enclosed by the four movable guide rails. A pair of the movable guide rails is configured to correspond to the first fixed guide rails of two working positions A respectively to form guide rails for the filter cylinder 1 to reciprocate between the two working positions A and the working position B of the assembly 2 for carrying and moving the filter cylinder. Another pair of the movable guide rails is configured to correspond to the first fixed guide rails of a third working position A respectively to form guide rails for the filter cylinder 1 to reciprocate between the third working position A and the working position B of the assembly 2 for carrying and moving the filter cylinder.

As shown in FIG. 20, the solid-liquid separation system includes four sets of the equipments. Two pairs of movable guide rails are arranged on the working position B. The four movable guide rails are arranged in a quadrilateral, and the pressure-bearing component is located at a center of the space enclosed by the four movable guide rails. Each pair of the movable guide rails is configured to correspond to the first fixed guide rails of two working positions A respectively to form guide rails for the filter cylinder 1 to reciprocate between the working positions A and the working position B of the assembly 2 for carrying and moving the filter cylinder.

1. A filter cloth laying assembly, including a laying and folding component and a dispensing component,
wherein, the dispensing component is configured to be located above a filter cylinder, the laying and folding component is used for laying a filter cloth in the filter cylinder, and the dispensing component is used for spraying downward materials to be treated onto the filter cloth.

2. The filter cloth laying assembly according to claim 1, wherein, the laying and folding component include: a telescopic pressing plate, a front cloth pressing member, a rear cloth pressing member and a cloth folding and scraping member;
in a movement direction of the filter cloth, the front cloth pressing member and the rear cloth pressing member are respectively provided on a first side and a second side, opposite to each other, of a top of the filter cylinder;
the telescopic pressing plate is fixed above the filter cylinder, and is located over the front cloth pressing member; and
the cloth folding and scraping member is configured to move back and forth between the first side and the second side of the filter cylinder to fold the filter cloth.

3. The filter cloth laying assembly according to claim 1, including a first frame;
wherein, the first frame is arranged on a periphery of the filter cylinder, and a top of the first frame is higher than a top of the filter cylinder;
the laying and folding component include: a telescopic pressing plate, a front cloth pressing member, a rear cloth pressing member and a cloth folding and scraping member;
an upper of the telescopic pressing plate is fixed on the first frame, the telescopic pressing plate is configured to be stretched out and drawn back up and down and is located over the front cloth pressing member;
the front cloth pressing member, the rear cloth pressing member and the cloth folding and scraping member are all arranged on the first frame, the front cloth pressing member is located on the first side of the top of the filter cylinder, and the rear cloth pressing member is located on the second side of the top of the filter cylinder;
the telescopic pressing plate and the front cloth pressing member are configured to press down the filter cloth on the first side of the cylinder body alternately; and
the cloth folding and scraping member is configured to move back and forth between the first side and the second side of the filter cylinder to lay the filter cloth, and the rear cloth pressing member presses down the filter cloth on the second side of the filter cylinder.

4. The filter cloth laying assembly according to claim 2 or 3, wherein, the front cloth pressing member includes a telescopic cloth pressing rod and a first support seat being capable of moving up and down;
a pair of front cloth pressing members are arranged at two ends of the first side of the top of the filter cylinder, and
the cloth pressing rod of the front cloth pressing member is configured to be horizontally stretched out and drawn back along the first side of the filter cylinder.

5. The filter cloth laying assembly according to any one of claims 2-4, wherein, the rear cloth pressing member includes a telescopic cloth pressing rod and a second support seat being capable of moving up and down;
a pair of the rear cloth pressing members are arranged at two ends of the second side of the top of the filter cylinder; and
the cloth pressing rod of the rear cloth pressing member is configured to be horizontally stretched out and drawn back along the second side of the filter cylinder.

6. The filter cloth laying assembly according to any one of claims 4-5, wherein, a lower of the telescopic pressure plate has a first groove being open downward;
both ends of the first groove in an extension direction of the first side of the top of the filter cylinder are respectively provided with an opening;
the cloth pressing rod of the front cloth pressing member is configured to be inserted into the first groove from the openings at both ends of the first groove respectively, and be pulled out of the first groove from a downward opening of the first groove to separate from the telescopic pressing plate.

7. The filter cloth laying assembly according to any one of claims 1 to 6, wherein, the cloth folding and scraping member includes a push plate, two third support seats and two movable slide rails;
the two movable slide rails are respectively attached on the first frame located on two sides of the filter cylinder in a movement direction of the filter cloth, and are respectively located on a side of the first support seat of the front cloth pressing member opposite to the filter cylinder;
the two third support seats are respectively located on the two movable slide rails, and the two movable slide rails are configured to be connected with and support the push plate; and
the push plate is configured to cross over the top of the filter cylinder.

8. The filter cloth laying assembly according to any one of claims 1 to 6, wherein, the cloth folding and scraping member includes a push plate, a third support seat and a movable slide rail;
the movable slide rail is attached to the first frame and located above the filter cylinder, and the third support seat is hung on the movable slide rail;
a bottom of the third support seat is connected with the push plate, and the push plate is configured to cross over the top of the filter cylinder.

9. The filter cloth laying assembly according to claim 7 or 8, wherein, a lower of the push plate has a second groove being open downward;
both ends of the second groove in an extension direction of the second side of the top of the filter cylinder are respectively provided with an opening;
the cloth pressing rod of the rear cloth pressing member is configured to be inserted into the second groove from the openings at both ends of the second groove respectively, and be pulled out of the second groove from a downward opening of the second groove to separate from the push plate when the second support seat is descended.

10. The filter cloth laying assembly according to claim 7 or 8, wherein, the push plate of the cloth folding and scraping member has a width in a movement direction of the filter cloth, and the push plate is configured as a front part and a rear part along a width direction;
the rear part is closer to the second side of the filter cylinder than the front part; and
the front part of the push plate is connected with the third support seat, and a lower surface of the rear part of the push plate is provided with the second groove.

11. The filter cloth laying assembly according to any one of claims 7 to 10, wherein, when the telescopic pressing plate is in an upwardly retracted state and the front cloth pressing member is in a downwardly moved state, a distance between the telescopic pressing plate and the front cloth pressing member is greater than a thickness of the push plate of the cloth folding and scraping member.

12. A solid-liquid separation system, including: a filter cloth laying assembly according to any one of claims 1 to 11, an assembly for carrying and moving the filter cylinder, a squeezing assembly, and an assembly for laying a filter cloth, unloading materials and rolling up a filter cloth;
wherein, the squeezing assembly is located above the filter cylinder, and the assembly for carrying and moving the filter cylinder is located below the filter cylinder;
in a horizontal direction, the filter cloth laying assembly and the squeezing assembly are arranged side by side; and
the filter cylinder is configured to move back and forth below the filter cloth laying assembly and the squeezing assembly through the assembly for carrying and moving the filter cylinder.

13. A solid-liquid separation system, including: a filter cloth laying assembly according to any one of claims 1 to 11, a squeezing assembly, a filter cylinder, and an assembly for laying a filter cloth, unloading materials and rolling up a filter cloth;
wherein, the filter cylinder includes a cylinder body and a movable bottom plate located in the cylinder body, the cylinder body is a hollow cubic structure of which sidewalls are provided with water outlet holes, a top and a bottom of the cylinder body are open, the movable bottom plate is matched with the cross section of an inner cavity of the cylinder body and is configured to move up and down along the cylinder body;
an assembly for carrying and moving the filter cylinder includes a working position A and a working position B, and the filter cylinder is configured to reciprocates between the working position A and the working position B;
two first fixed guide rails are arranged at a working position A, parallel to each other, and extended toward a working position B, a lifter is located between the two first fixed guide rails and configured to support the movable bottom plate;
two movable guide rails are arranged at a working position B and parallel to each other, and the two movable guide rails are configured to move up and down, and the two movable guide rails are respectively connected to the two first fixed guide rails and are on a same straight line, and the pressure-bearing member is located between the two movable guide rails;
the filter cloth laying assembly includes a laying and folding component and a dispensing component, the dispensing component is located above a filter cylinder on the working position A, the laying and folding component is used for laying a filter cloth in the filter cylinder, and the dispensing component is used for spraying downward materials to be treated onto the filter cloth;
the squeezing assembly includes a hydraulic device and a squeezing plate, and the hydraulic device and the squeezing plate are arranged above the cylinder body at the working position B, the hydraulic device drives the squeezing plate to squeeze downward from the opening of the top of the cylinder body; and
the assembly for laying a filter cloth, unloading materials and rolling up a filter cloth is located on one side of the working position A, and cooperates with the filter cloth laying assembly to roll up and lay the filter cloth.

14. The solid-liquid separation system according to claim 12 or 13, wherein, assembly for laying a filter cloth, unloading materials and rolling up a filter cloth includes an unloading component, a filter cloth arranging component and a filter cloth rolling and laying component which are connected in sequence;
the unloading component includes a driving guide roller, a material discharging conveyor tangent to the driving guide roller;
the filter cloth arranging component includes a first free guide roller, a second free guide roller and a third free guide roller, being in a V shape;
a wrinkle removing roller is located between the second free guide roller at a bottom of the V shape and the first free guide roller on one side, a scrubber located between the second free guide roller at the bottom of the V shape and the third free guide roller on the other side;
the filter cloth rolling and laying component includes a corrector and a cloth roller, and the corrector is located between the filter cloth arranging component and the cloth roller;
preferably, the cloth roller is located below the filter cloth arranging component.

15. The solid-liquid separation system according to claim 14, wherein the wrinkle removing roller in the filter cloth arranging component is in a working position and an idle position;
when the filter cloth is rolled up and materials is removed, the wrinkle removing roller is in the working position, and the two wrinkle removing rollers are in contact with the filter cloth and pull the filter cloth between two free guide rollers in two opposite directions to tension the filter cloth to remove the wrinkles of the filter cloth; and
when the filter cloth is laid, the wrinkle removing roller is in the idle position and not in contact with the filter cloth.

16. The solid-liquid separation system according to claim 14 or 15, wherein, a scrubber of the filter cloth arranging component includes a high-pressure sprayer, a rotating brush and a flushing back plate;
the high-pressure sprayer and the rotating brush are on a same side of the filter cloth opposite to the flushing back plate; the flushing back plate is located on the other side of the filter cloth; and
multiple high-pressure sprayer and rotating brushes in each of scrubbers are arranged at intervals.

17. The solid-liquid separation system according to any one of claims 14 to 16, wherein, the filter cloth arranging component includes a water collecting and draining member, the water collecting and draining member is located below and on the side of the V shape consisted by three free guide rollers, for collecting all rinse water and discharging the rinse water from a drainage port.

18. A solid-liquid separation system, including: a filter cloth laying assembly, an assembly for carrying and moving the filter cylinder, a squeezing assembly, a filter cylinder, and an assembly for laying a filter cloth, unloading materials and rolling up a filter cloth;
wherein, the assembly for carrying and moving the filter cylinder includes a working position A and a working position B, and the squeezing assembly is configured to squeeze materials at working position B;
two first fixed guide rails are arranged at a working position A, parallel to each other, and extended toward a working position B, a lifter is located between the two first fixed guide rails;
one pair or two pairs of movable guide rails are arranged at a working position B, the two movable guide rails are configured to move up and down, and each pair of movable guide rails are respectively connected to the two first fixed guide rails of at least one working position A and are on a same straight line, and the pressure-bearing member is located between one or two pairs of movable guide rails;
the filter cylinder, the working position A of the assembly for carrying and moving the filter cylinder, the apparatus for laying a filter cloth, and the assembly for laying a filter cloth, unloading materials and rolling up a filter cloth are combined into a set of equipment;
one set of or sets of the equipments are arranged around the working position B and the squeezing assembly.

19. The solid-liquid separation system according to claim 18, wherein, two sets of the equipments are provided around the working position B and the squeezing assembly; two sets of the equipments are arranged on both sides of the working position B and the squeezing assembly;
the solid-liquid separation system is in a straight line as a whole in the horizontal direction; or, the solid-liquid separation system is in an L shape as a whole in the horizontal direction.

20. The solid-liquid separation system according to claim 18, wherein, three sets of the equipments are provided;
the three sets of the equipments are arranged around the working position B and the squeezing assembly, and the solid-liquid separation system as a whole is in T-shaped.

21. The solid-liquid separation system according to claim 18, wherein, four sets of the equipments are provided, and
the four sets of the equipments are arranged around the working position B and the squeezing assembly, and the solid-liquid separation system as a whole is in two straight lines perpendicular to each other.

22. The solid-liquid separation system according to any one of claims 18 to 21, wherein:
the filter cylinder includes a cylinder body and a movable bottom plate located in the cylinder body, the cylinder body is a hollow cubic structure of which sidewalls are provided with water outlet holes, a top and a bottom of the cylinder body are open, the movable bottom plate is matched with the cross section of an inner cavity of the cylinder body and is configured to move up and down along the cylinder body;
the filter cylinder is configured to reciprocates between the working position A and the working position B;
the filter cloth laying assembly includes a laying and folding component and a dispensing component, the dispensing component is configured to be located above a filter cylinder on the working position, the laying and folding component is used for laying a filter cloth in the filter cylinder, and the dispensing component is used for spraying downward materials to be treated onto the filter cloth;
the squeezing assembly includes a hydraulic device and a squeezing plate, and the hydraulic device and the squeezing plate are arranged above the cylinder body at the working position B, the hydraulic device drives the squeezing plate to squeeze downward from the opening of the top of the cylinder body; and
the assembly for laying a filter cloth, unloading materials and rolling up a filter cloth is located on one side of the working position A, and cooperates with the filter cloth laying assembly to roll up and lay the filter cloth.
